(19) United States
(12) Patent Application Publication
(10) Pub. No.: US 2013/0262534 A1
(43) Pub. Date: Oct. 3, 2013

(54) INFORMATION PROCESSING APPARATUS, NON-TRANSITORY COMPUTER-READABLE MEDIUM AND INFORMATION PROCESSING METHOD

(71) Applicant: CANON KABUSHIKI KAISHA, Tokyo (JP)

(72) Inventor: Takeshi Hayakawa, Kawasaki-shi (JP)

(73) Assignee: CANON KABUSHIKI KAISHA, Tokyo (JP)

(21) Appl. No.: 13/793,462

(22) Filed: Mar. 11, 2013

(30) Foreign Application Priority Data
Mar. 28, 2012 (JP) 2012-074887

(51) Int. Cl. G06F 17/30

(52) U.S. Cl. CPC G06F 17/30115
USPC 707/822

(57) ABSTRACT

An information processing apparatus comprises a determination unit configured to determine whether an operation has been performed for data within a folder which was referred to by a user; and a display unit configured to display history data of a folder which was referred to and in which data has been operated without displaying history data of a folder which was referred to and in which data has not been operated.

### BACKGROUND OF THE INVENTION

1. Field of the Invention

The present invention relates to an information processing apparatus, a non-transitory computer-readable medium, and an information processing method and, more particularly, to a display control method for the folder access histories of a file management application.

2. Description of the Related Art

It is important to use and organize files in an operation performed in an information terminal such as a personal computer. The user can more readily and efficiently perform an operation involving file access using a file management application. For example, the user can easily find a folder in which a file used before is saved. Japanese Patent Laid-Open No. 2000-56885 discloses a technique of providing, on a file selection screen, a menu for referring to a folder designated in advance in order to make it easy to find and reuse a file.

In the technique described in Japanese Patent Laid-Open No. 2000-56885, however, it is necessary to preset a file or folder to be referred to in a file management application, and therefore, the user needs to make settings every time, for example, a new folder is created. If maintenance operations such as change and deletion operations are not performed for the set contents, the settings in the file management application may become complicated, resulting in a long time to access a file.

To solve this problem, the file management application has a function of automatically storing folders accessed by the user, and displaying them as options. It is possible to improve the user convenience using the folders set by the user and those automatically stored by the file management application. If, however, folders accessed by the user are automatically stored, folders which are only passed through and are not actually needed by the user are also registered as histories when the folder layer is deep. As a result, an increase in the number of histories makes user options complicated.

### SUMMARY OF THE INVENTION

According to one aspect of the present invention, there is provided an information processing apparatus comprising: a determination unit configured to determine whether an operation has been performed for data within a folder which was referred to by a user; and a display unit configured to display history data of a folder which was referred to and in which data has been operated without displaying history data of a folder which was referred to and in which data has not been operated.

According to another aspect of the present invention, there is provided a non-transitory computer-readable medium storing a program for causing a computer to function as determining whether an operation has been performed for data within a folder which was referred to by a user, and displaying history data of a folder which was referred to and in which data has been operated without displaying history data of a folder which was referred to and in which data has not been operated.

According to another aspect of the present invention, there is provided an information processing method comprising: determining whether an operation has been performed for data within a folder which was referred to by a user; and displaying history data of a folder which was referred to and in which data has been operated without displaying history data of a folder which was referred to and in which data has not been operated.

The present invention allows the user to readily access a folder in which a file used before is stored, thereby making it more convenient to access the file again and use associated files.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of an information processing apparatus;

FIG. 2 is a view showing an example of a file management application;

FIG. 3 is a view showing another example of the file management application;

FIG. 4 is a view showing an example of a data structure generated by the file management application;

FIG. 5 is a flowchart illustrating processing of generating a history data information structure by the file management application;

FIG. 6 is a view showing an example of a data structure generated by the file management application;

FIG. 7 is a flowchart illustrating processing of assigning a storage flag to the history data information structure in the file management application;

FIG. 8 is a view showing an example of a data structure generated by the file management application;

FIG. 9 is a view showing an example of the file management application;

FIG. 10 is view showing an example of a file management application;

FIG. 11 is a flowchart illustrating processing of generating a history data information structure by the file management application;

FIG. 12 is a view showing an example of the file management application;

FIG. 13 is view showing an example of a file management application;

FIG. 14 is a flowchart illustrating processing of generating a history data information structure by the file management application; and

FIG. 15 is a view showing an example of a data structure generated by the file management application.

### DESCRIPTION OF THE EMBODIMENTS

### First Embodiment

A mode for carrying out the present invention will be described below with reference to the accompanying drawings. An embodiment of the present invention stores, in a storage medium, software program codes for implementing functions described in this specification. The functions are also implemented when the computer (or a CPU or an MPU) of an apparatus or a system including an information processing apparatus reads out and executes the program codes stored in the storage medium.

[Apparatus Arrangement]

An arrangement assumed in the embodiment will be described first. An information processing apparatus 100 according to the present invention includes a file management application having a function of filing, independently of an operating system (OS), document data generated by a general-purpose application.

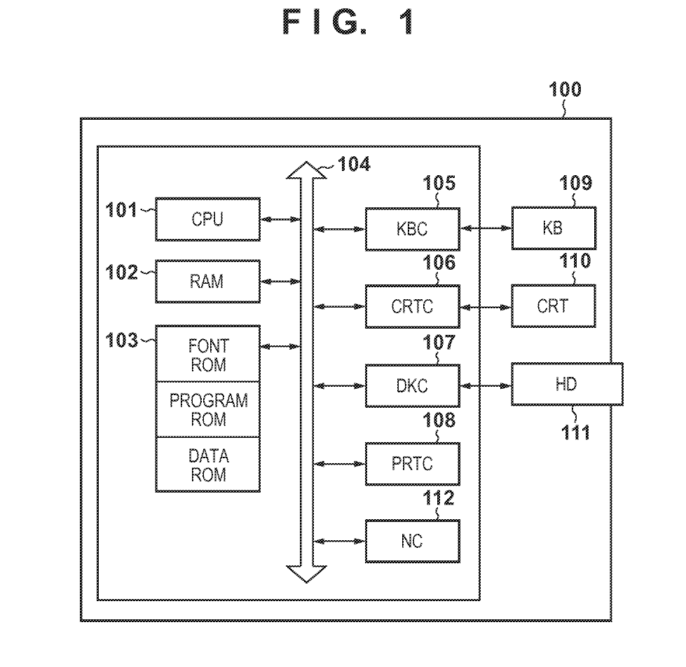

FIG. 1 is a block diagram showing the arrangement of the information processing apparatus 100 adaptive to the embodiment. Referring to FIG. 1, a CPU 101 executes a program such as an OS or general-purpose application loaded from a ROM 103 or hard disk 111 serving as a storage unit into a RAM 102, thereby implementing each flowchart (to be described later).

The RAM 102 functions as a main memory, a work area, or the like for the CPU 101. A keyboard controller (KBC) 105 controls key inputs from a keyboard 109 or a pointing device (not shown). A CRT controller (CRTC) 106 controls display of a CRT display 110 serving as a display unit. Note that the display unit is not limited to the CRT display, and other kinds of displays may be used. A disk controller (DKC) 107 controls access to the hard disk 111 or Floppy® disk (FD) storing, for example, a boot program, various applications, font data, user files, and edit files (to be described later). A PRTC 108 controls to exchange a signal with a connected printer. An NC 112 is connected to a network to execute communication control processing for another device connected to the network.

[File Management Application]

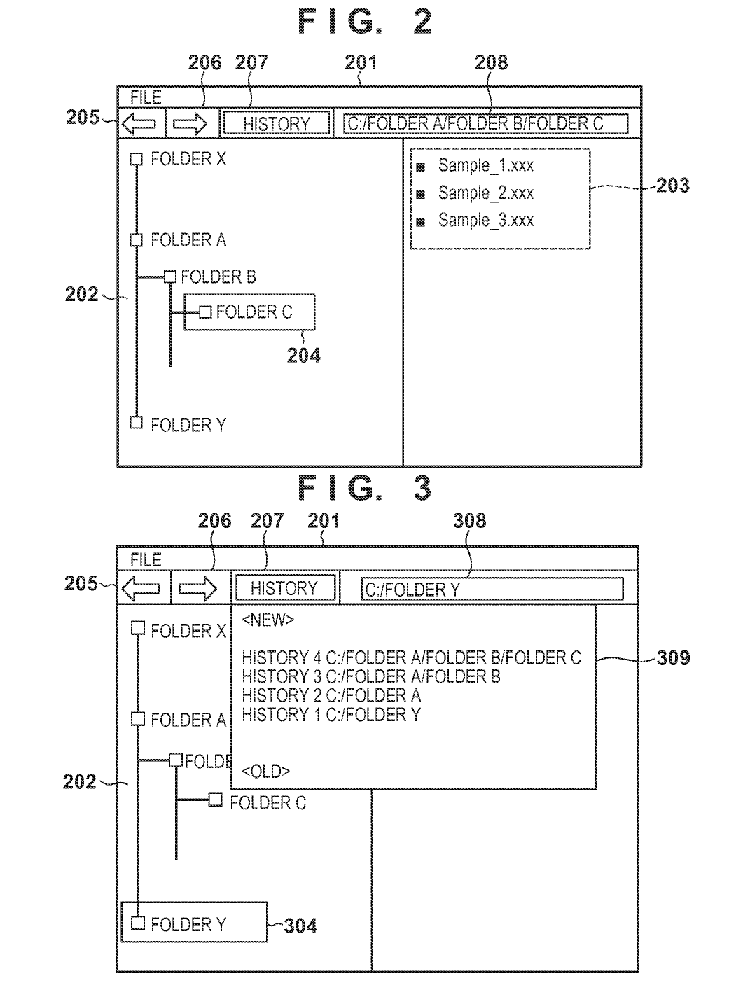

FIG. 2 is a view showing a display example of a UI screen 201 in the file management application adaptive to the embodiment, which will be simply referred to as a file management application hereinafter.

The file management application includes a folder tree view 202 for separating files into folder layers and managing them, and a file view 203 for displaying files within a folder. Referring to FIG. 2, the folder tree view 202 displays five folders, that is, folders X, Y, A, B, and C. Except for the root folder, folders X, A, and Y are highest folders. A folder 204 represents a folder (folder C in this example) selected by the user, and files immediately under the selected folder 204 are displayed in the file view 203. Note that although not shown in FIG. 2, if the selected folder includes a folder as a lower layer, the folder may be displayed in the file view 203. That is, the user can select one of the folders displayed in the folder tree view 202 in the file management application, and refer to files and folders included in the selected folder.

Referring to FIG. 2, the user can recognize from the file view 203 and the selected folder 204 that folder C includes three files Sample_{—}1.xxx, Sample_{—}2.xxx, and Sample_{—}3.xxx.

When the user presses a back button 205, the file management application displays a folder selected immediately before the selected folder 204. When the user presses a forward button 206, the file management application displays a folder selected immediately after the selected folder 204. The forward button 206 is enabled by pressing the back button 205. If there is no folder selected after the currently selected folder, it is impossible to use (press) the forward button 206.

A history display button 207 will be described with reference to FIG. 3. The file path of the currently selected folder is displayed in an address bar 208. That is, in FIG. 2, “C:/folder A/folder B/folder C” which is the file path of the selected folder 204 is displayed.

FIG. 3 is a view showing another display example of the UI screen of the file management application adaptive to the embodiment. More specifically, FIG. 3 is a view for explaining a case in which the history display button 207 is pressed in the file management application shown in FIG. 2. The same parts as those in FIG. 2 have the same reference numerals, and a detailed description will be omitted.

Referring to FIG. 3, a selected folder 304 indicates “folder Y”. In this case, when the user presses the history display button 207, the file management application displays a history list 309. The history list 309 is used to selectably display a list of the histories of folders which were accessed by the user before. If the user designates one history of the history list 309, the selected folder 304 in the file management application transits to a folder of a folder path indicated by the designated history.

The history list 309 includes, for example, four histories. History 1 indicates “C:/folder Y”; history 2, “C:/folder A”; history 3, “C/folder A/folder B”; and history 4, “C:/folder A/folder B/folder C”. In this display example, history 1 is oldest, and history 4 is newest. Note that the history display order may be set by the user, for example, may be set to arrange the oldest history at the top. As in the history list 309, the display order may be displayed.

History 4 corresponds to the selected folder 204 (folder C) in FIG. 2. Since the folder 304 is selected in FIG. 3, an address bar 308 displays “C:/folder Y” as the folder path of the selected folder 304.

[History Data Structure (No. 1)]

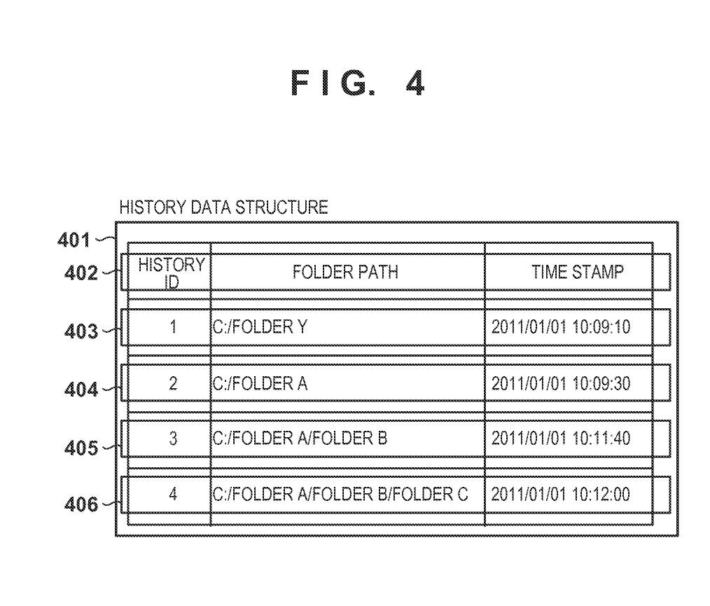

FIG. 4 is a view showing an example of a data structure generated by the file management application. A history data structure 401 is stored using the storage area of the ROM 103 or hard disk 111 of the information processing apparatus 100 shown in FIG. 1. The history data structure 401 is used by the file management application to manage history data associated with accessed folders.

The history data structure 401 includes information of folders displayed in the history list 309 shown in FIG. 3. Items 402 indicate the respective items of stored history data. The items are a history ID (identifier) for identifying history data, a folder path, and a time stamp representing time of day information when a corresponding folder is referred to. History data 403 to 406 indicate individual history data included in the history data structure 401. That is, in this example, the history data structure 401 is formed by a group of history data 403 to 406.

For example, a folder path corresponding to history ID “1” is associated with “C:/folder Y”. The file management application has used the history data 403 to 406 before the history list 309 is displayed.

[History Data Structure Generation Processing]

A flowchart illustrating processing of generating the history data structure 401 in the file management application, which is the characteristic of the embodiment, will be described.

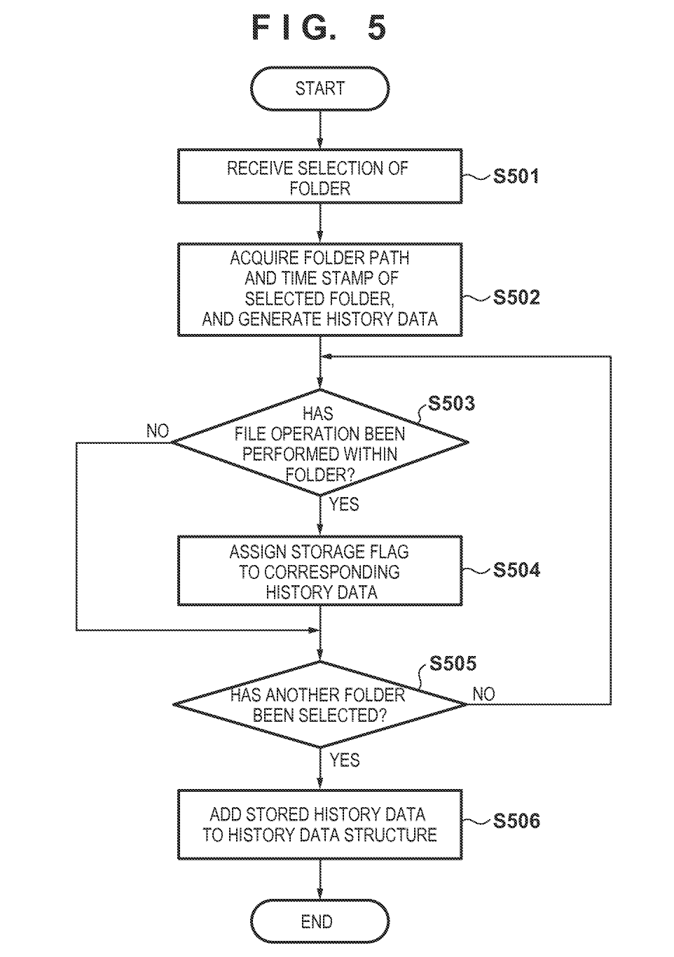

FIG. 5 is a flowchart illustrating processing in the file management application. Note that the flowchart in this application is implemented when the CPU (or MPU) reads out and executes associated program codes stored in the storage medium.

The flowchart shown in FIG. 5 is executed by the file management application when, for example, the user designates the folder 304 shown in FIG. 3.

In step S501, the file management application receives a folder selection instruction from the user. In step S502, the file management application acquires the folder path and time stamp of a selected folder, and generates history data for the history data structure 401. The generated history data is temporarily stored in a work area memory such as the RAM 102 which can be used by the file management application.

In step S503, the file management application determines whether a file operation has been performed for a file within the selected folder. The “file operation” indicates, for example, opening, deleting, copying, moving, or newly generating a file, or changing a file name. The file operation in this embodiment is generally a read/write operation for a file, that is, an operation involving file access. Note that the determination processing in step S503 is adaptive to a similar operation involving file access. For example, file copy or movement applies. If a file operation has been performed (YES in step S503), the process advances to step S504; otherwise (NO in step S503), the process advances to step S505.

In step S504, the file management application assigns a storage flag to the history data generated in step S502. Note that although the storage flag indicates, for example, “presence” or “absence”, other settings may be used. For example, the default value of the storage flag is set to “0”. When a file operation is performed, the value of the storage flag may be set to “1” indicating “valid”. That is, it is only necessary to assign, to the history data, information for determining whether a file operation has been performed for a file immediately under the selected folder. In step S505, the file management application determines whether the user has instructed to move from the folder instructed in step S501 to another folder (the user has selected another folder). If the user has moved to another folder (YES in step S505), the process advances to step S506; otherwise (NO in step S505), the process returns to step S503.

The processing in steps S503 to S505 is loop processing. Note that the processing in steps S503 to S505 is asynchronous processing. That is, the processing in step S505 is not always executed immediately after the processing in step S503. The file management application can execute polling processing or event processing to detect whether the user has moved to another folder, while a folder is selected. If the user has selected another folder, the file management application adds history data to the history data structure 401 in step S506. The process is then terminated.

[History Data Structure (No. 2)]

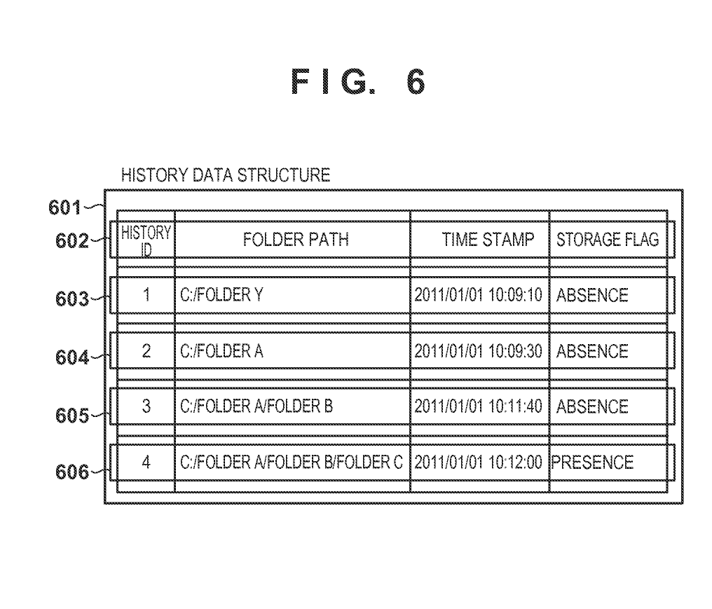

FIG. 6 shows an example of history data generated by the file management application as a result of the processing shown in FIG. 5. A history data structure shown in FIG. 6 is obtained by extending the history data structure 401 shown in FIG. 4, and is generated by the file management application using the storage area of the ROM 103 or hard disk 111 of the information processing apparatus 100 shown in FIG. 1, similarly to the history data structure 401.

A history data structure 601 is history data structure information used by the file management application to manage history folders. The history data structure 601 includes information of the folders displayed in the history list 309. Items 602 indicate the respective items of stored information. In addition to the items 402, an item “storage flag” is provided. The storage flag is added in step S504.

History data 603 to 605 indicate the individual history data of the history data structure 601. The history data 603 to 605 are obtained when no operation has been performed for a file within a corresponding folder in step S503 of FIG. 5, and each corresponding storage flag indicates “absence”. Only for history data 606, a file operation has been performed within a corresponding folder, and a corresponding storage flag indicates “presence”. That is, when the user moves through folders in the file management application, he/she has only referred to the folder indicated by “C:/folder Y”, “C:/folder A”, or “C:/folder A/folder B”. On the other hand, the user has performed a file operation for a file within the folder indicated by “C:/folder A/folder B/folder C”.

[History Display Processing]

Display of the histories in the file management application will now be described. In this embodiment, when the user presses the history display button 207 of the file management application, the histories are displayed.

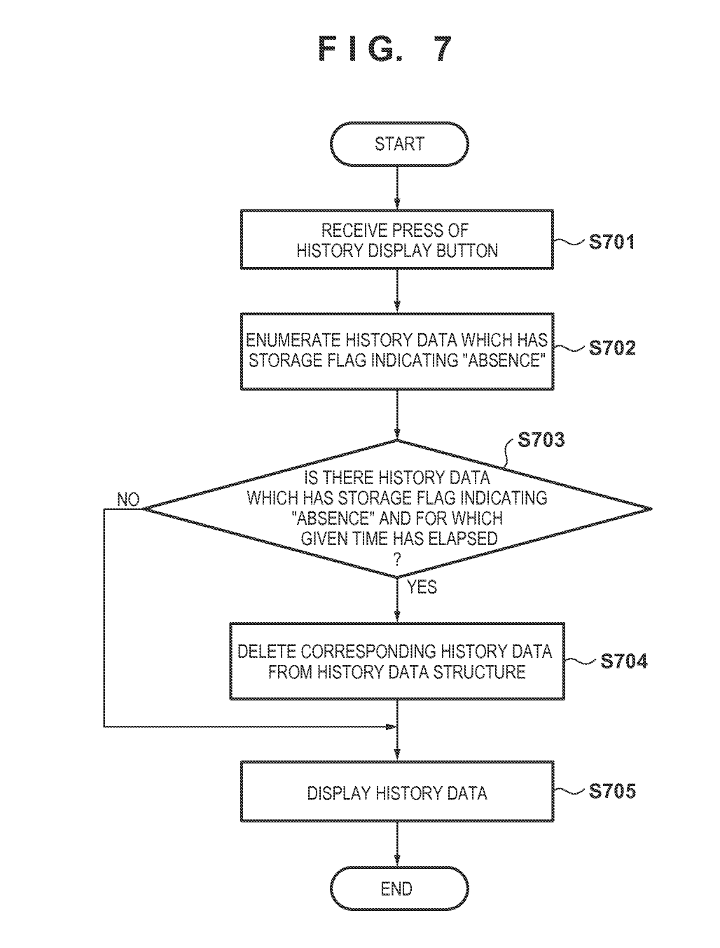

FIG. 7 is a flowchart illustrating processing in the file management application when, for example, the user designates the folder 304 as shown in FIG. 3.

In step S701, the file management application receives an instruction indicating that the user has pressed the history display button 207 shown in FIG. 2. In step S702, the file management application enumerates some of the history data 603 to 606 of the history data structure 601, each of which has a storage flag indicating “absence”. That is, in the example shown in FIG. 6, the history data 603 to 605 are enumerated.

In step S703, the file management application acquires the time stamp information of each history data enumerated in step S702, and compares it with the current time of day. As a result of the comparison processing, the file management application determines whether there is history data for which a given time has elapsed. The given time need only be a predetermined value in the file management application. Alternatively, the user may set this value. In this embodiment, assume that the given time is “5 minutes”, and the current time of day is “2011/01/01 10:15:00”.

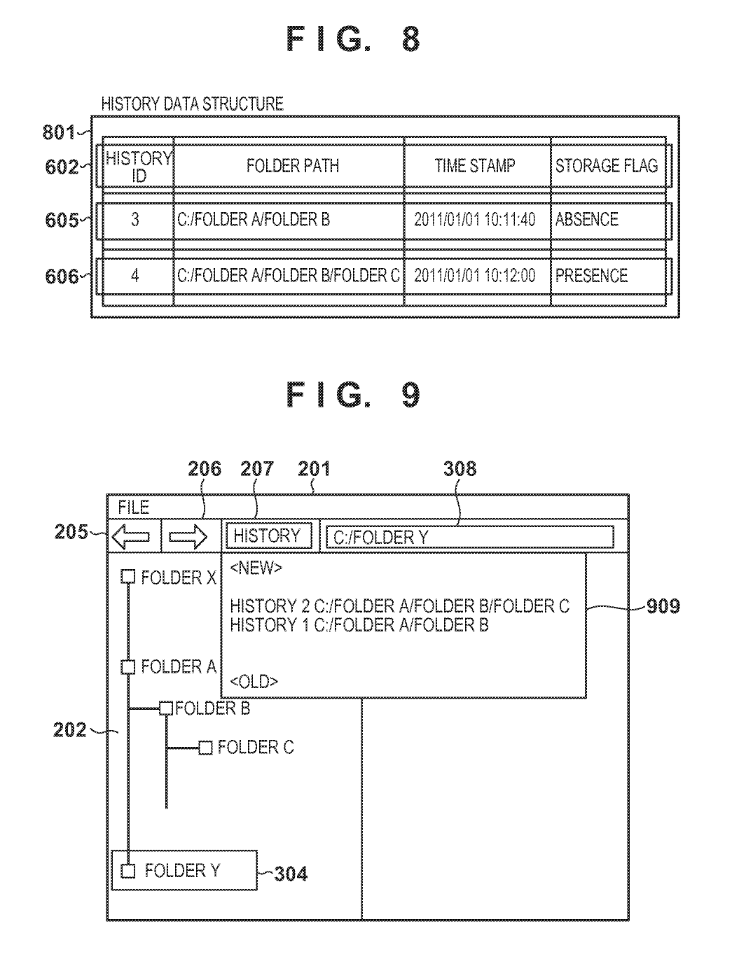

If there is history data, among the enumerated history data, for which the given time has elapsed (YES in step S703), the process advances to step S704. On the other hand, if there is no history data for which the given time has elapsed (NO in step S703), the process advances to step S705. In step S704, the file management application deletes, from the history data structure 601, the history data for which the given time has elapsed with respect to the current time of day. Since the given time is “5 minutes” and the current time of day is “2011/01/01 10:15:00”, corresponding history data are the history data 603 and 604. The history data 603 and 604, therefore, are deleted. As a result, by updating the history data structure 601 by the file management application in step S704, a history data structure 801 shown in FIG. 8 is obtained. In step S705, the file management application uses the history data structure 801 shown in FIG. 8 to generate a history list 909 shown in FIG. 9.

[History Data Structure (No. 3)]

FIG. 8 shows the history data structure 801 generated by the file management application as a result of the processing shown in FIG. 7. The history data structure 801 shown in FIG. 8 is obtained as a result of updating the history data structure 601 shown in FIG. 6 in step S704 of FIG. 7. The history data structure 601 shown in FIG. 6 includes the history data 603 to 606. The history data 603 and 604, however, have been deleted in step S704, and therefore, the history data structure 801 includes the history data 605 and 606.

[Display of Updated History Data]

FIG. 9 is a view showing the UI screen of the file management application adaptive to the embodiment. FIG. 9 shows the history list 909 displayed by the file management application in step S705 shown in FIG. 7.

The screen shown in FIG. 9 has the same arrangement as that shown in FIG. 3 except for the history list 909. The history list 909 is used to display a list of histories generated based on the history data structure 801. The history data structure 801 is used to update the history list 309, thereby displaying only the history data 605 and 606.

As described above, in this embodiment, not all the folders which were referred to by the user in the past are displayed as histories. If the user accessed a file within a folder, the folder is considered as a usable history, and then displayed. Furthermore, not all the folders which were referred to in the past are deleted, and folders which were referred to within a given time are displayed as histories. With the history display method according to the embodiment, histories displayed to the user are not complicated, thereby improving the usability of a history list.

Note that if no operation has been performed on the information processing apparatus for a predetermined time, history data need not be deleted even when a given time has elapsed after a corresponding folder was referred to. For example, the user may be away from the information processing apparatus, and therefore, cannot perform any operation. In this case, the information processing apparatus may include a clocking unit (timer or the like) for determining a period of time during which the user does not perform any operation.

If the file management application runs again, history data stored when the file management application ended last time may be displayed.

If there are a plurality of history data, history data with a longer folder path may be preferably displayed. This is because a time taken for user access is longer as a folder layer is deeper.

An upper limit of the number of data displayed as histories may be set. That is, if the upper limit is exceeded, history data with a lower priority level may be deleted.

Note that the items described above may be individually set by the user, and displayed by the user as needed.

In this embodiment, a storage flag is assigned according to whether a file operation has been performed for a file immediately under a selected folder. The present invention, however, is not limited to this, and a storage flag may be assigned even if an operation has been performed for a folder immediately under a selected folder. An operation for a folder includes, for example, copying or deleting the folder, or changing the name of the folder.

### Second Embodiment

In the first embodiment, the method of displaying a list of histories using the history display button of the file management application has been described. A case in which histories are always displayed even if there is no instruction, for example, even if the user does not press the button can be considered. In this case, a method other than the method of updating the history data structure by pressing the button as shown in FIG. 7 may be used. In the second embodiment, processing of always displaying histories will be described.

In this embodiment, FIGS. 1, 5, 6, and 8 are the same as those in the first embodiment, and a description thereof will be omitted. In the second embodiment, changes are made to the display of the histories in the file management application shown in FIG. 3 and the flowchart illustrating the processing of updating the display of the histories shown in FIG. 7 according to the first embodiment.

[File Management Application]

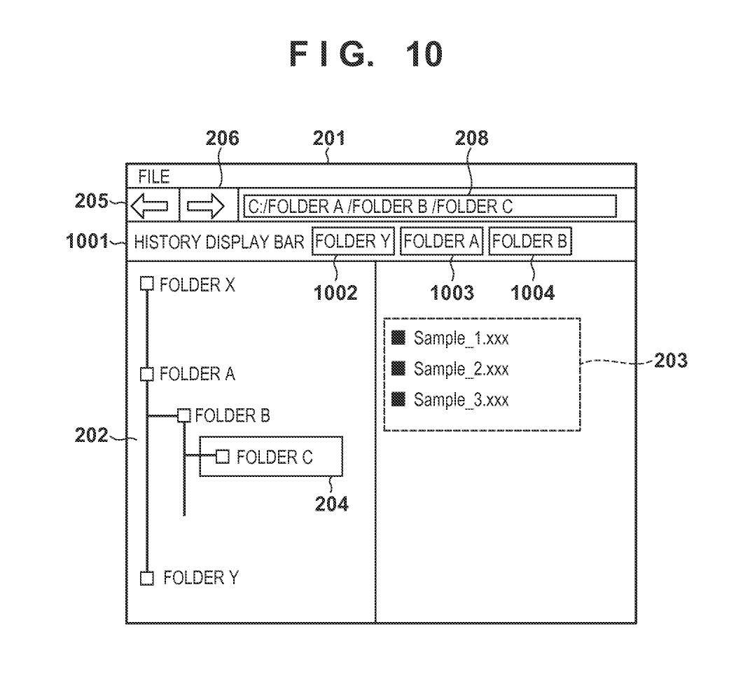

FIG. 10 is a view showing the UI screen of a file management application adaptive to the embodiment. Referring to FIG. 10, histories are displayed using not the history display button 207 in the file management application shown in FIG. 2 but a history display bar 1001. The same parts as those in FIG. 2 have the same reference numerals, and a detailed description thereof will be omitted.

Unlike the history display button 207 shown in FIG. 2, a folder corresponding to history data can be automatically displayed in the history display bar 1001 without pressing any button by the user. In this example, history folders 1002 to 1004 are selectably displayed in the form of buttons (shortcuts) in the history display bar 1001. The user can select one of the history folders 1002 to 1004 to refer to a corresponding folder, and display contents of the folder in a file view 203.

This provides the same effects as those obtained by selecting a history from the history list 309 displayed by pressing the history display button 207 in FIG. 3. According to this embodiment, the histories are always displayed in the file management application, thereby making the number of operation steps smaller than that in the first embodiment. Furthermore, even if display of a folder tree view 202 is complicated because a folder is positioned in a deep layer, the screen arrangement shown in FIG. 10 enables to simplify the display using the history display bar.

The history folders 1002 to 1004 are folders corresponding to history data 603 to 605 of a history data structure 601 shown in FIG. 6, respectively. For example, the history folder 1002 is associated with the file path (folder Y) of the history data 603. If the user selects the history folder 1002, a selected folder in the file management application transits to the file path of the history data 603.

Similarly, the history folder 1003 is associated with the file path (folder A) of the history data 604. Furthermore, the history folder 1004 is associated with the file path (folder B) of the history data 605. In the state shown in FIG. 10, a selected folder 204 indicates “folder C”, and therefore, history data 606 of folder C is not displayed yet.

[History Data Structure Generation Processing]

A flowchart illustrating processing of generating a history data structure by the file management application, which is the characteristic of the second embodiment, will be described.

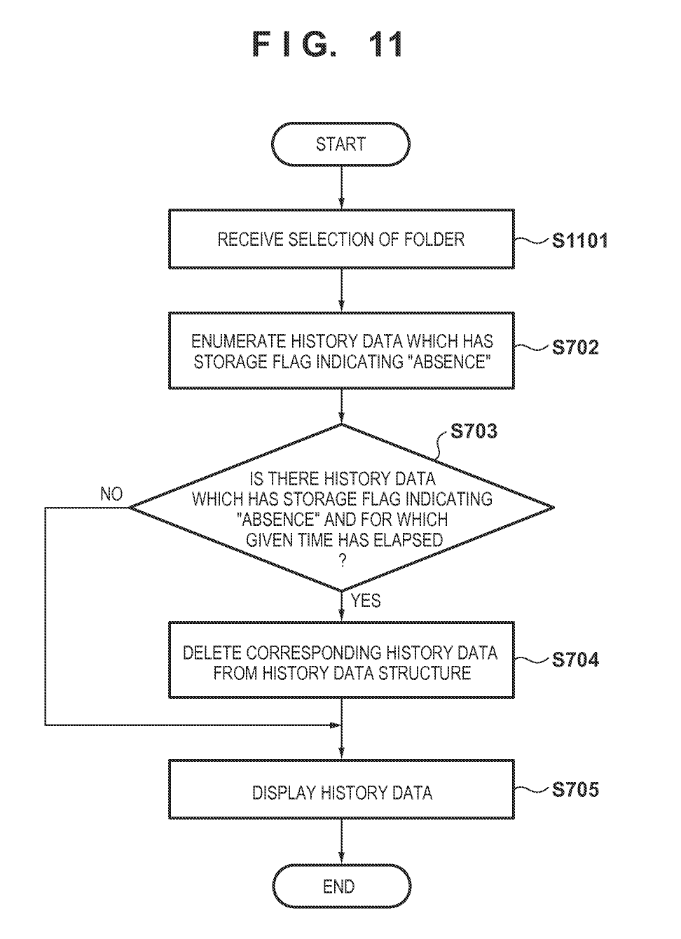

FIG. 11 is a flowchart illustrating processing by the file management application.

In the flowchart shown in FIG. 11, processing in step S1101 is executed instead of that in step S701 shown in FIG. 7. In step S1101, the file management application receives an instruction indicating that the user has selected a folder. This processing is done at the same timing as that of the processing in step S501 shown in FIG. 5. The processes illustrated by the flowcharts shown in FIGS. 5 and 11 are independent of each other, and either process may be executed first. Alternatively, these processes may be parallelly executed.

The same processes as those in FIG. 7 have the same reference symbols, and a detailed description thereof will be omitted.

[Display of Updated History Data]

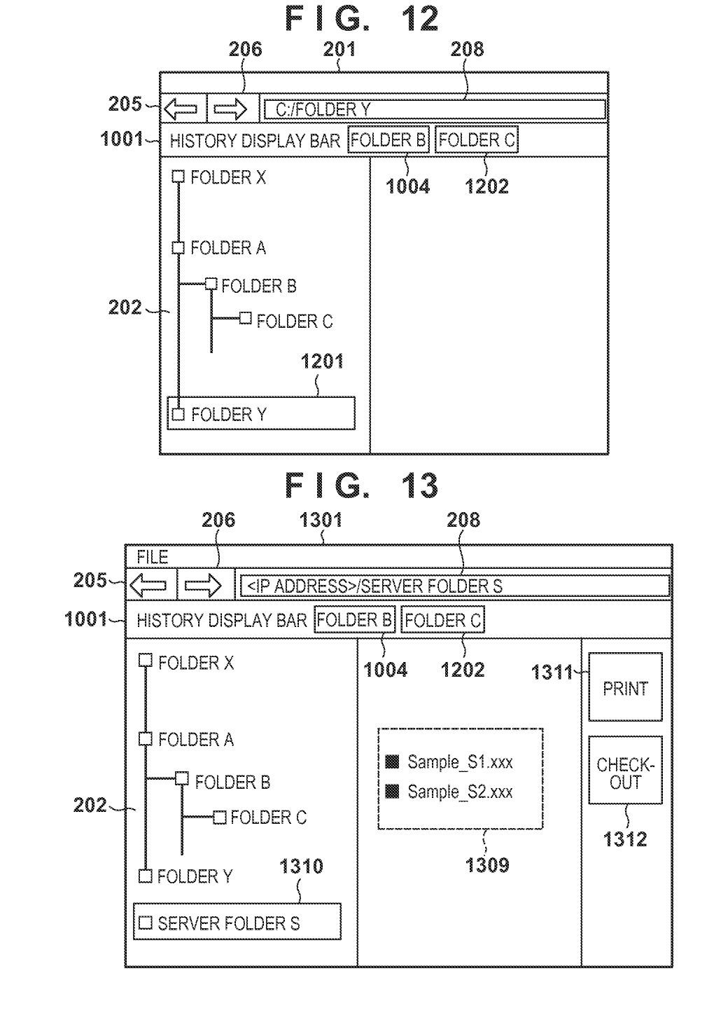

FIG. 12 is a view showing the UI screen of the file management application adaptive to the embodiment. FIG. 12 shows a result obtained by executing the processing procedure shown in FIG. 11 in the file management application shown in FIG. 10. The same parts as those in FIG. 2 have the same reference numerals, and a detailed description thereof will be omitted. Furthermore, the same parts as those in FIG. 10 have the same reference numerals, and a detailed description thereof will be omitted.

Referring to FIG. 12, the user has selected a folder, and a folder displayed in the folder view has been changed from the folder 204 (folder C) shown in FIG. 10 to a folder 1201 (folder Y). The file management application executes the processing procedures shown in FIGS. 5 and 11 when the folder 1201 is selected. As a result, contents of the history display bar 1001 are updated. In steps S703 and S704 of FIG. 11, unnecessary history data are deleted, and thus the history folders 1002 and 1003 are no longer displayed in the history display bar 1001. After that, a history folder 1202 is newly displayed in the history display bar 1001. The history folder 1202 corresponds to the folder 204 (folder C) selected before the folder is changed.

As described above, in this embodiment, in addition to the first embodiment, it is possible to execute deletion processing for unnecessary histories while always displaying histories in the file management application. This enables the user to use the histories without complication.

### Third Embodiment

According to the first and second embodiments, the usability when referring to folder histories is improved by displaying, as histories, folders including files which were accessed. Operations other than open and movement operations, however, are also performed for a file within a folder. In the third embodiment, a method of performing processing of determining whether to execute various functions for a file, and assigning a storage flag as a history will be described.

FIGS. 1 to 12 are the same as those in the first and second embodiments, and a description thereof will be omitted. In the third embodiment, a file management application obtained by providing multiple functions to that in the first or second embodiment is used. The third embodiment may be used in combination with either the first or second embodiment.

[File Management Application]

FIG. 13 is a view showing a UI screen 1301 of the file management application adaptive to the embodiment. Note that the same parts as those in the first and second embodiments have the same reference numerals, and a description thereof will be omitted.

The file management application according to this embodiment is basically the same as that in the first embodiment but additionally includes a print function and checkout function. A folder view 1309 and a selected server folder S 1310 indicate that the server folder S includes two files Sample_S1.xxx and Sample_S2.xxx.

A different point from the first and second embodiments is that the selected server folder S 1310 refers to a folder in an information processing apparatus different from that of the file management application. As the selected server folder S 1310, a folder stored in a general-purpose file server (not shown) is assumed. The file management application can refer to the server folder S 1310 on the file server via a network (not shown). A print button 1311 is one of the functions of the file management application. By pressing the print button 1311 while a file is selected, it is possible to instruct to print the selected file. To instruct to print a file, the file may be dragged and dropped into the print button 1311. A checkout button 1312 is one of the functions of the file management application. By pressing the checkout button 1312 while a file is selected, the selected file is exclusively locked. The function indicates a general-purpose checkout function. Note that a check-in operation may be performed after a checkout operation but a description thereof will be omitted. The checkout button 1312 is enabled when the server folder S 1310 is selected. If a folder (for example, folder X or A) within the apparatus on which the file management application operates is selected, the checkout button 1312 is disabled. In this case, the checkout button 1312 is grayed out, or the button itself disappears.

[History Data Structure Generation Processing]

A flowchart illustrating processing of generating a history data structure by the file management application according to the embodiment will now be described.

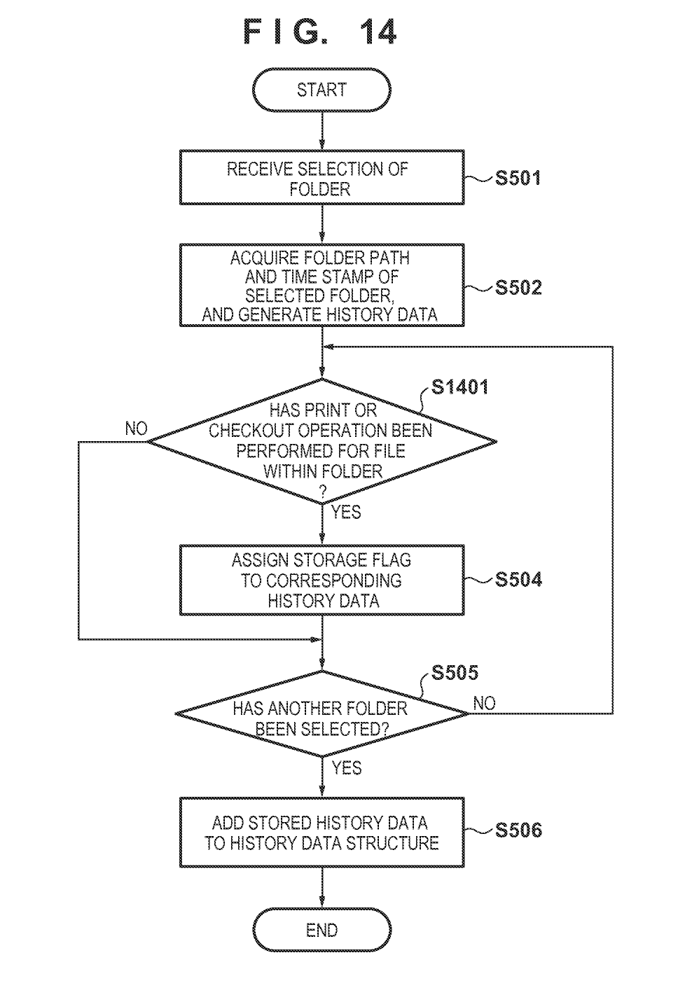

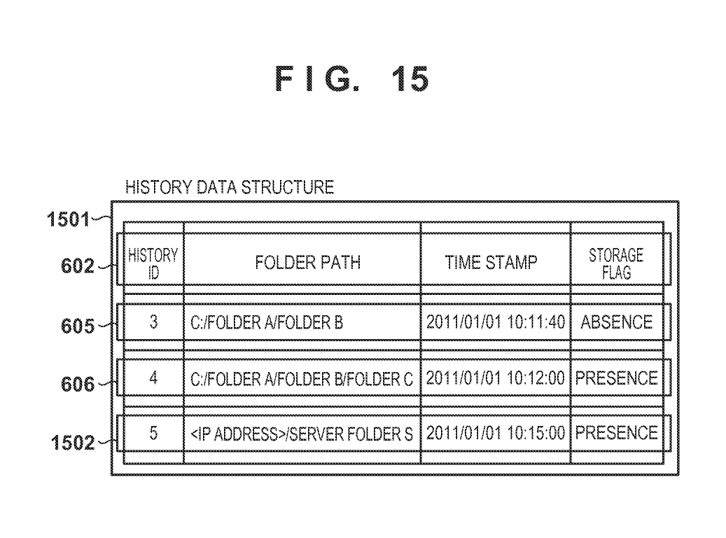

FIG. 14 is a flowchart illustrating processing in the file management application.

The flowchart shown in FIG. 14 illustrates processing executed by the file management application when the user designates the server folder S 1310, similarly to FIG. 3. The flowchart shown in FIG. 14 is the same as that shown in FIG. 5 except for determination whether to assign a storage flag. Note that the same processes as those of the file management application shown in FIG. 5 have the same reference symbols, and a detailed description thereof will be omitted.

After generating history data in step S502, the file management application determines in step S1401 whether a file operation for print or checkout has been performed for a file within the selected folder. For the print operation, it is determined whether the user has instructed to execute the operation through the print button 1311. For the checkout operation, it is determined whether the user has instructed to execute the operation through the checkout button 1312. If the file operation has been performed (YES in step S1401), the process advances to step S504; otherwise (NO in step S1401), the process advances to step S505. Processing after that is the same as that shown in FIG. 5.

[History Data Structure]

FIG. 15 shows an example of a history data structure 1501 generated by the file management application in the processing shown in FIG. 14.

The history data structure 1501 is generated by the file management application using the storage area of a ROM 103 or hard disk 111 of an information processing apparatus 100 shown in FIG. 1, similarly to FIG. 6. Note that the same parts as those in FIG. 6 have the same reference numerals, and a detailed description thereof will be omitted. History data 1502 is generated when it is determined in step S1401 of FIG. 14 that the storage flag is set. Even if a print or checkout operation is performed for a file within the selected server folder S 1310, the storage flag is set to indicate “presence”.

As described above, in the file management application according to this embodiment, even if a print or checkout operation other than a file access operation is executed, corresponding history data has priority to remain. This results in improvement in user friendliness when accessing a folder using histories.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-074887, filed Mar. 28, 2012, which is hereby incorporated by reference herein in its entirety.

What is claimed is:

1. An information processing apparatus comprising:
a determination unit configured to determine whether an operation has been performed for data within a folder which was referred to by a user; and
a display unit configured to display history data of a folder which was referred to and in which data has been operated without displaying history data of a folder which was referred to and in which data has not been operated.

2. The apparatus according to claim 1, further comprising
a storage unit configured to store, as history data, a folder path of a folder which was referred to by the user, and time of day information when the folder was referred to, and
a deletion unit configured to use the time of day information to delete history data of a folder, among the history data stored in said storage unit, in which data has not been operated and for which a given time has elapsed since the folder was referred to.

3. The apparatus according to claim 2, wherein said deletion unit executes deletion processing for history data when a folder to be referred to is changed.

4. The apparatus according to claim 2, wherein said deletion unit executes deletion processing for history data when a user instruction to display the history data on said display unit is received.

5. The apparatus according to claim 1, wherein said display unit displays the history data when a folder to be referred to is changed.

6. The apparatus according to claim 2, wherein said deletion unit preferably deletes history data whose folder path is shorter than that of another history data.

7. A non-transitory computer-readable medium storing a program for causing a computer to function as
determining whether an operation has been performed for data within a folder which was referred to by a user, and
displaying history data of a folder which was referred to and in which data has been operated without displaying history data of a folder which was referred to and in which data has not been operated.

8. The medium according to claim 7, for causing the computer to further function as
storing, as history data, a folder path of a folder which was referred to by the user, and time of day information when the folder was referred to, and
using the time of day information to delete history data of a folder, among the stored history data, in which data has not been operated and for which a given time has elapsed since the folder was referred to.

9. The medium according to claim 8, wherein deletion processing for history data is executed when a folder to be referred to is changed.

10. The medium according to claim 8, wherein deletion processing for history data is executed when a user instruction to display the history data on the display unit is received.

11. The medium according to claim 8, wherein the history data is displayed when a folder to be referred to is changed.

12. The medium according to claim 8, wherein history data whose folder path is shorter than that of another history data is deleted.

13. An information processing method comprising:
determining whether an operation has been performed for data within a folder which was referred to by a user; and
displaying history data of a folder which was referred to and in which data has been operated without displaying history data of a folder which was referred to and in which data has not been operated.

14. The method according to claim 13, for causing the computer to further function as
storing, as history data, a folder path of a folder which was referred to by the user, and time of day information when the folder was referred to, and
using the time of day information to delete history data of a folder, among the stored history data, in which data has not been operated and for which a given time has elapsed since the folder was referred to.

15. The method according to claim 13, wherein deletion processing for history data is executed when a folder to be referred to is changed.

16. The method according to claim 13, wherein deletion processing for history data is executed when a user instruction to display the history data on the display unit is received.

17. The method according to claim 13, wherein the history data is displayed when a folder to be referred to is changed.

18. The method according to claim 13, wherein history data whose folder path is shorter than that of another history data is deleted.
